(19) United States
(12) Patent Application Publication
(10) Pub. No.: US 2012/0146952 A1
(43) Pub. Date: Jun. 14, 2012

(54) OPTICAL TOUCH PANEL

(75) Inventors: Suntak Park, Daejeon (KR); Seung Koo Park, Daejeon (KR); Jung Jin Ju, Daejeon (KR); Min-Su Kim, Daejeon (KR); Jin Tae Kim, Daejeon (KR); Ki-Uk Kyung, Daejeon (KR)

(73) Assignee: ELECTRONICS AND TELECOMMUNICATIONS RESEARCH INSTITUTE, Daejeon (KR)

(21) Appl. No.: 13/206,620

(22) Filed: Aug. 10, 2011

(30) Foreign Application Priority Data
Dec. 8, 2010 (KR) 10-2010-0125028

(51) Int. Cl. G06F 3/042

(52) U.S. Cl. 345/175

(57) ABSTRACT

Provided is an optical touch panel. The optical touch panel includes: an optical waveguide including a core delivering an optical signal and a clad surrounding the core; a light generator delivering the optical signal into the optical waveguide; and a light detector measuring the optical signal passing through the optical waveguide, wherein the optical waveguide includes a sensing part having a sensing surface and a passing part having a non-sensing surface; the core includes a sensing core portion in the sensing part and a passing core portion in the passing part; and a distance between the sensing surface and a top surface of the sensing core portion is shorter than that between the non-sensing surface and a top surface of the passing core portion.

### CROSS-REFERENCE TO RELATED APPLICATIONS

This U.S. non-provisional patent application claims priority under 35 U.S.C. §119 of Korean Patent Application No. 10-2010-0125028, filed on Dec. 8, 2010, the entire contents of which are hereby incorporated by reference.

### BACKGROUND OF THE INVENTION

The present invention disclosed herein relates to an optical touch panel, and more particularly, to an optical touch panel including an optical waveguide.

A touch screen is a device that once a finger or an object touches a letter or a specific position displayed on a screen, a specific function is processed by detecting its position without using an input device such as a keyboard or a mouse. This touch screen panel is extensively applied to various fields such as banks, government and public offices, diverse medical equipments, tourist guidance, and major institution guidance. Also, the touch screen panel is applied to PDAs, mobile phones, and monitors and its application fields and functions expand. Especially, due to the increasing smart phone with a built-in optical touch panel, an advanced function such as multi-touch is required, and from now on, it is expected that a 3-dimensional touch panel and a flexible touch panel are on demand as various high-tech products such as a 3-dimesional display and e-paper.

### SUMMARY OF THE INVENTION

The present invention provides an optical touch panel having flexibility and proximity sensing.

The present invention also provides a high-performance touch screen panel of multi-sensing.

Embodiments of the present invention provide optical touch panels including: an optical waveguide including a core delivering an optical signal and a clad surrounding the core; a light generator delivering the optical signal into the optical waveguide; and a light detector measuring the optical signal passing through the optical waveguide, wherein the optical waveguide includes a sensing part having a sensing surface and a passing part having a non-sensing surface; the core includes a sensing core portion in the sensing part and a passing core portion in the passing part; and a distance between the sensing surface and a top surface of the sensing core portion is shorter than that between the non-sensing surface and a top surface of the passing core portion.

In some embodiments, a thickness of the clad covering the sensing core portion may be thinner than that of the clad covering the passing core portion.

In other embodiments, the sensing surface may include the top surface of the sensing core portion.

In still other embodiments, the clad may include an upper clad covering a top surface of the core and a lower clad covering a bottom surface of the core; and the sensing surface and the non-sensing surface may be disposed at the same level based on the a bottom surface of the lower clad.

In even other embodiments, based on the bottom surface of the lower clad, the top surface of the sensing core portion may be disposed at a higher level than the top surface of the passing core portion.

In yet other embodiments, based on the bottom surface of the lower clad, a bottom surface of the sensing core portion may be disposed at a higher level than a bottom surface of the passing core portion.

In further embodiments, a width of the sensing core portion may be broader than that of the passing core portion in a direction vertical to a direction that the optical waveguide extends.

In still further embodiments, the clad may include an upper clad covering a top surface of the core and a lower clad covering a bottom surface of the core; and based on the bottom surface of the lower clad, the non-sensing surface may be disposed at a higher level than the sensing surface.

In even further embodiments, based on a bottom surface of the lower clad, the top surface of the sensing core portion and the top surface of the passing core portion may be disposed at the same level.

In yet further embodiments, a width of the sensing core portion may be identical to that of the passing core portion in a direction vertical to a direction that the optical waveguide extends.

In yet further embodiments, in a plane view, a width of the sensing core portion may be different from that of the passing core portion in a direction perpendicular to a direction that the core extends.

In yet further embodiments, the sensing part may include a scatter pattern scattering the optical signal.

In yet further embodiments, the optical touch panels may further include a mirror inserted into the sensing core portion and reflecting the optical signal, wherein the optical waveguide includes: a main part including the sensing part; an input part connected to one end of the main part and receiving the optical signal; and an output part connected to the one end of the main part and outputting the optical signal, and further including an optical filter disposed on an intersection region of the main part, the input part, and the output part and delivering an optical signal reflected by the sensing part to the output part.

In yet further embodiments, the optical waveguide may be provided in plurality, further including an optical divider receiving the optical signal to divide the optical signal into the cores.

In yet further embodiments, the optical waveguide may be a first optical waveguide, further including a second optical waveguide intersecting the first optical waveguide, wherein the sensing part is disposed in an intersection region of the first and second optical waveguides.

In yet further embodiments, the second optical waveguide may be provided in plurality; the plurality of second optical waveguides may intersect the first optical waveguide; and the sensing part may be provided in plurality in an intersection region of the first optical waveguide and the second optical waveguide.

In yet further embodiments, the optical waveguide may be provided in plurality and the optical waveguides extend in parallel in a first direction; the sensing parts may form rows and columns, respectively, along a direction vertical to the first direction and a second direction; the second direction may be non-vertical and non-parallel to the first direction; and the second direction may be parallel to one side of a display panel.

In yet further embodiments, the optical touch panel may further include a touch sensitive layer including a plurality of protrusions.

In yet further embodiments, the light generator may include: a light source generating the optical signal; and at least one lends converting the optical signal into a direction parallel to an extension direction of the optical waveguide and delivering the converted optical signal into the optical waveguide.

In yet further embodiments, the passing core portion may include first and second passing core portions at both sides of the sensing core portion; the sensing core portion provided in plurality; one ends of the plurality of sensing core portions are connected to one end of the first passing core portion; and the other ends of the plurality of sensing core portions are connected to one end of the second passing core portion.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view illustrating an optical touch panel according to an embodiment of the present invention;

FIGS. 2A through 2D are sectional views taken along the line A-A′ of FIG. 1 to describe a sensing part and a passing part in an optical waveguide according to a first embodiment and its modifications of the present invention;

FIGS. 3A through 3D are sectional views taken along the line A-A′ of FIG. 1 to describe a sensing part and a passing part in an optical waveguide according to a second embodiment and its modifications of the present invention;

FIGS. 3A through 3D are sectional views illustrating a sensing part and a passing part in an optical waveguide according to a second embodiment of its modifications of the present invention;

FIGS. 4A through 4C are plan views illustrating a sensing part and a passing part in an optical waveguide according to a third embodiment of its modifications of the present invention;

FIGS. 5A through 5C are sectional views taken along the line B-B′ of FIG. 1 to describe a core in an optical waveguide according to a fourth embodiment and its modifications of the present invention;

FIG. 6 is a view illustrating an optical touch panel including an optical waveguide according to a fifth embodiment of the present invention;

FIGS. 7A through 7D are sectional views taken along the line C-C′ of FIG. 6 to describe a sensing part in an optical waveguide according to a fifth embodiment and its modifications of the present invention;

FIGS. 8A through 8B are views illustrating an optical touch panel including an optical waveguide according to a sixth embodiment and its modifications of the present invention;

FIG. 9 is a view illustrating an optical touch panel according to a seventh embodiment of the present invention;

FIGS. 10A and 10B are views illustrating a optical touch panel including optical waveguides according to an eighth embodiment and its modifications of the present invention;

FIGS. 11A and 11B are views illustrating a light emitting part in an optical touch panel according to an embodiment and its modifications of the present invention;

FIG. 12 is a view illustrating a touch screen panel and a display panel in an optical touch panel according to an embodiment of the present invention; and

FIG. 13 is a view illustrating a touch sensitive layer in an optical touch panel according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

In the drawings, the dimensions of layers and regions are exaggerated for clarity of illustration. It will also be understood that when a layer (or film) is referred to as being ‘on’ another layer or substrate, it can be directly on the other layer or substrate, or intervening layers may also be present. Further, it will be understood that when a layer is referred to as being ‘under’ another layer, it can be directly under, and one or more intervening layers may also be present. In addition, it will also be understood that when a layer is referred to as being ‘between’ two layers, it can be the only layer between the two layers, or one or more intervening layers may also be present. Like reference numerals refer to like elements throughout.

An optical touch panel according to an embodiment of the present invention is described.

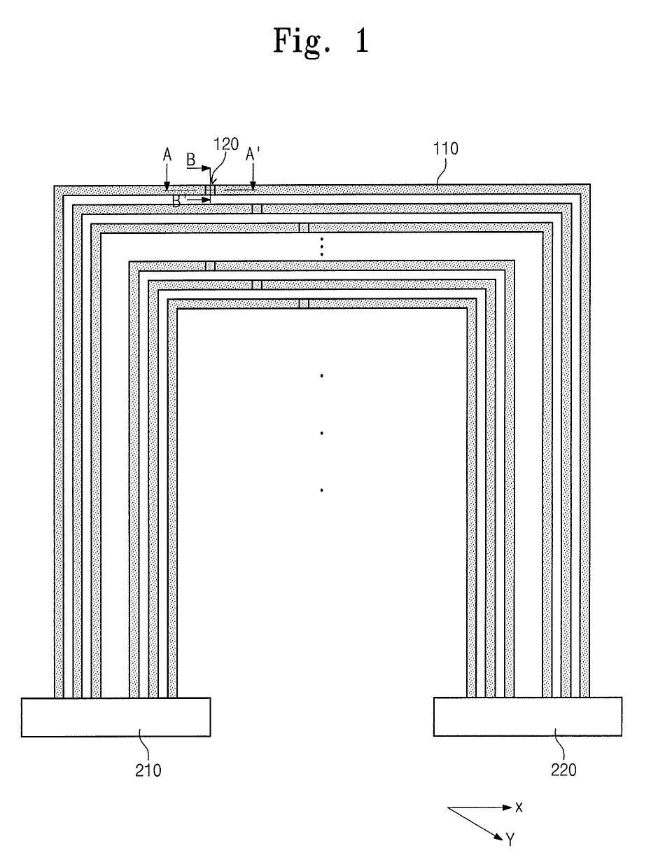

FIG. 1 is a view illustrating an optical touch panel according to an embodiment of the present invention.

Referring to FIG. 1, the optical touch panel may include a plurality of optical waveguides 110, a light generator 210, and a light detector 220. The light generator 210 may be connected to one ends of the optical waveguides 110. The light generator 210 may supply optical signals to the optical waveguides 110. The light detector 220 may be connected to the other ends of the waveguides 110. The optical detector 220 may measure the optical signals passing through the optical waveguides 110. According to an embodiment, the light detector 220 may measure intensities of the optical signals. In this case, the optical detector 220 may include a Charge-Coupled Device (CCD) or a Complementary Metal-Oxide-Semiconductor (CMOS).

The plurality of optical waveguides 110 may include a portion extending in a first direction. The optical waveguides 110 may include a core and a clad surrounding the core. The core may deliver the optical signals received from the light generator 210. A refractive index of the clad may be less than that of the core. The first direction may correspond to an x-axis direction in the drawings.

The optical waveguides 110 extending in the first direction may include sensing parts 120. According to an embodiment, one optical waveguide 110 may include one sensing part 120. The sensing parts 120 may be arranged in a second direction intersecting the first direction. The second direction may be non-vertical and non-parallel to the first direction. The second direction may be oblique to the first direction. The second direction may correspond to a y-axis direction in the drawings.

According to an embodiment, the sensing parts 120 form columns in a direction perpendicular to the first direction and form rows in the second direction. In a plane view, the sensing parts 120 are shown with a rectangular but may be formed with various figures such as a circle, an oval, or a polygon.

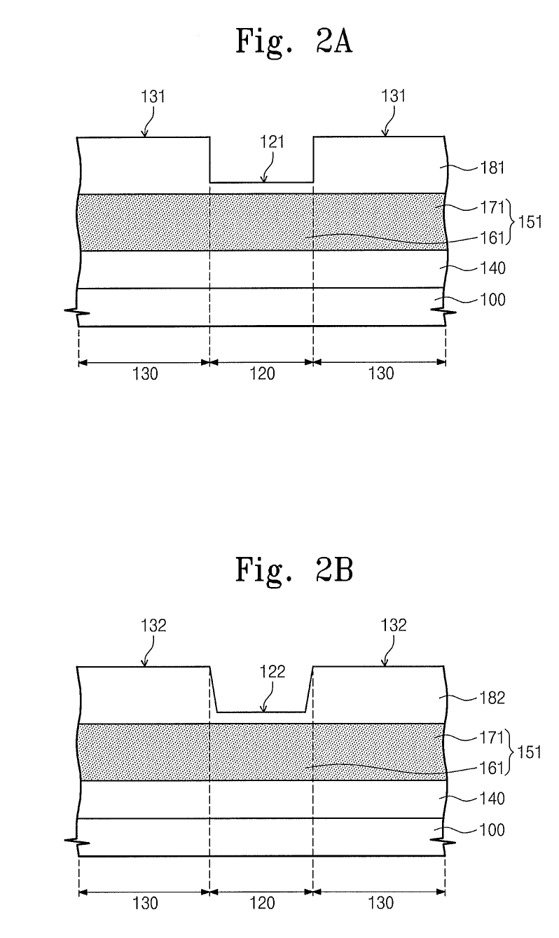

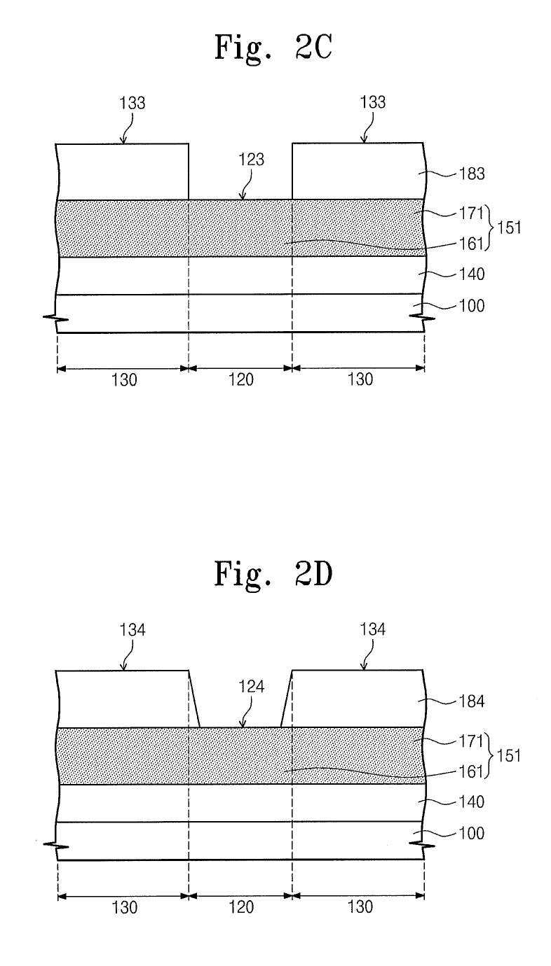

When a part of a human body and/or an object contacts and/or approaches the sensing parts 120, the optical signals delivered from the core of the optical waveguides 110 may be changed. According to an embodiment, the intensities of the optical signals may be changed. Thus, the light detector 220 may detect positions of the sensing parts 120 that a part of a human body and/or an object contacts and/or approaches. This is described with reference to FIGS. 2A through 2D.

A sensing part and a passing part in the optical waveguide according to the first embodiment of the present invention are described. FIG. 2A is a sectional view taken along the line A-A′ of FIG. 1 to describe a sensing part and a passing part in the optical waveguide according to the first embodiment of the present invention.

Referring to FIG. 2A, the optical waveguide may include a core 151 on a substrate 100, and lower and upper clads 140 and 181 surrounding the core 151. The upper clad 181 covers a top surface of the core 151 and the lower clad 140 covers a bottom surface of the core 151. According to an embodiment, the substrate 100 may be a flexible substrate including a polymer film. Unlike this, the substrate 100 may be a glass substrate or a plastic substrate.

The optical waveguide may include a sensing part 120 and passing parts 130 at both sides of the sensing part 120. The sensing part 120 may include a sensing surface 121. The passing parts 130 may include non-sensing surfaces 131. When a part of a human body and/or an object contacts and/or approaches the non-sensing surfaces 131, the optical signal passing through the optical waveguide may not changed.

The core 151 includes a sensing core portion 161 and passing core portions 171. The sensing core portion 161 may be a portion of the core 151 in the sensing part 120. The passing core portions 171 may be a portion of the core 151 in the passing parts 130. Based on the bottom surface of the lower clad 140, the top surface of the sensing core portion 161 and the top surfaces of the passing core portions 171 may be positioned at the same level. Based on the bottom surface of the lower clad 140, the bottom surface of the sensing core portion 161 and the bottom surfaces of the passing core portions 171 may be positioned at the same level. Therefore, the width of the sensing core portion 161 may be the same as the passing core portions 171 in a direction vertical to the top surface of the substrate 100.

The lower clad 140 may be disposed between the substrate 100 and the core 151. The upper clad 181 may cover the top surface of the core 151. The thickness of the upper clad 181 covering the top surface of the sensing core portion 161 may be thinner than that of the upper clad 181 covering the top surfaces of the passing core portions 171.

The sensing surface 121 may include the top surface of the upper clad 181 covering the top surface of the sensing core portion 161. The non-sensing surfaces 131 may include the top surface of the upper clad 181 covering the top surfaces of the passing core portions 171. Based on the bottom surface of the lower clad 140, the sensing surface 121 may be disposed at a first level and the non-sensing surfaces 131 may be disposed at a second level higher than the first level. The distance between the sensing surface 121 and the top surface of the sensing core portion 161 may be shorter than that between the non-sensing surfaces 131 and the top surface of the passing core portion 171.

The sensing core portion 161 and the passing core portion 171 may include central points. For example, the distance between the central point of the sensing core portion 161 and the top surface of the sensing core portion 161 may be identical to that between the central point of the sensing core portion 161 and the bottom surface of the sensing core portion 161. The distance between the central point of the passing core portion 171 and the top surface of the passing core portion 171 may be identical to that between the central point of the passing core portion 171 and the bottom surface of the passing core portion 171. The distance between the central points of the sensing surface 121 and the sensing core portion 161 may be shorter than that between the central points of the non-sensing surfaces 131 and the passing core portion 171.

A sensing part and a passing part in the optical waveguide according to a first modification of the first embodiment of the present invention are described. FIG. 2B is a sectional view taken along the line A-A′ of FIG. 1 to describe a sensing part and a passing part in the optical waveguide according to the first modification of the first embodiment of the present invention.

Referring to FIG. 2B, the optical waveguide may include the substrate 100, the lower clad 140, and the core 151, which are described with reference to FIG. 2A. The optical waveguide includes a sensing part 120 including a sensing surface 122 and passing parts 130 including non-sensing surfaces 132 and disposed at both sides of the sensing part 120.

An upper clad 182 may cover the top surface of the sensing core portion 161 and the top surfaces of the passing core portions 171. The thickness of the upper clad 182 covering the top surface of the sensing core portion 161 may be thicker progressively closer to the passing part 130. The thickness of the upper clad 182 covering the central portion of the top surface of the sensing core portion 161 may be thinner than that of the upper clad 182 covering the edge of the top surface of the sensing core portion 161.

The sensing surface 122 may include the top surface of the upper clad 182 covering the top surface of the sensing core portion 161. The non-sensing surfaces 131 may include the top surface of the upper clad 182 covering the top surfaces of the passing core portions 171. Based on the bottom surface of the lower clad 140, the sensing surface 124 may be disposed at a first level and the non-sensing surfaces 134 may be disposed at a second level higher than the first level. The distance between the sensing surface 121 and the top surface of the sensing core portion 161 may be shorter than that between the non-sensing surfaces 132 and the top surface of the passing core portion 171. The distance between the sensing surface 122 and the central point of the sensing core portion 162 may be shorter than that between the non-sensing surface 132 and the central point of the passing core portion 171.

A sensing part and a passing part in the optical waveguide according to a second modification of the first embodiment of the present invention are described. FIG. 2C is a sectional view taken along the line A-A′ of FIG. 1 to describe a sensing part and a passing part in the optical waveguide according to the second modification of the first embodiment of the present invention.

Referring to FIG. 2C, the optical waveguide may include the substrate 100, the lower clad 140, and the core 151, which are described with reference to FIG. 2A. The optical waveguide includes a sensing part 120 including a sensing surface 123 and passing parts 130 including non-sensing surfaces 133 and disposed at both sides of the sensing part 120.

An upper clad 183 may be disposed on the core 151. The upper clad 183 does not cover the top surface of the sensing core portion 161, and may cover the top surfaces of the passing core portions 171. Thus, the top surface of the sensing core portion 161 may be exposed.

The sensing surface 123 may include the top surface of the exposed sensing core portion 161. The distance between the sensing surface 123 and the top surface of the sensing core portion 161 may be 0. The non-sensing surface 133 may include the top surface of the upper clad 183 covering the top surface of the passing core portion 171. Based on the bottom surface of the lower clad 140, the sensing surface 123 may be disposed at a first level and the non-sensing surfaces 133 may be disposed at a second level higher than the first level. The distance between the sensing surface 121 and the top surface of the sensing core portion 161 may be shorter than that between the non-sensing surfaces 133 and the top surface of the passing core portion 171. The distance between the sensing surface 122 and the central point of the sensing core portion 162 may be shorter than that between the non-sensing surface 133 and the central point of the passing core portion 171.

A sensing part and a passing part in the optical waveguide according to a third modification of the first embodiment of the present invention are described. FIG. 2D is a sectional view taken along the line A-A′ of FIG. 1 to describe a sensing part and a passing part in the optical waveguide according to the third modification of the first embodiment of the present invention.

Referring to FIG. 2D, the optical waveguide may include the substrate 100, the lower clad 140, and the core 151, which are described with reference to FIG. 2A. The optical waveguide includes a sensing part 120 including a sensing surface 124 and passing parts 130 including non-sensing surfaces 134 and disposed at both sides of the sensing part 120.

An upper clad 184 may be disposed on the core 151. The upper clad 184 does not cover the central portion of the top surface of the sensing core portion 161, and may cover the edge of the top surfaces of the passing core portions 161. Thus, the central portion of the top surface of the sensing core portion 161 may be exposed. The upper clad 184 may cover the top surfaces of the passing core portions 171. The thickness of the upper clad 184 covering the edge of the top surface of the sensing core portion 161 may be thicker progressively closer to the passing parts 130.

The sensing surface 124 may include the central portion of the top surface of the exposed sensing core portion 161. According to an embodiment, the sensing surface 124 may further include the top surface of the upper clad 184 covering the sensing core portion 161. The non-sensing surface 134 may include the top surface of the upper clad 184 covering the top surface of the passing core portion 171. Based on the bottom surface of the lower clad 140, the sensing surface 124 may be disposed at a first level and the non-sensing surfaces 134 may be disposed at a second level higher than the first level. The distance between the sensing surface 124 and the top surface of the sensing core portion 161 may be shorter than that between the non-sensing surfaces 134 and the top surface of the passing core portion 171. The distance between the sensing surface 124 and the central point of the sensing core portion 162 may be shorter than that between the non-sensing surface 134 and the central point of the passing core portion 171.

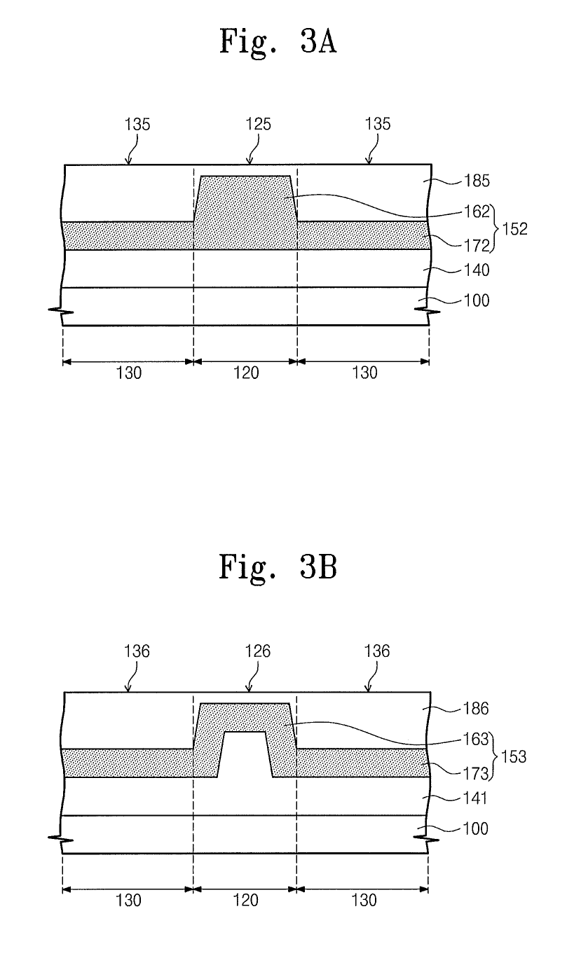

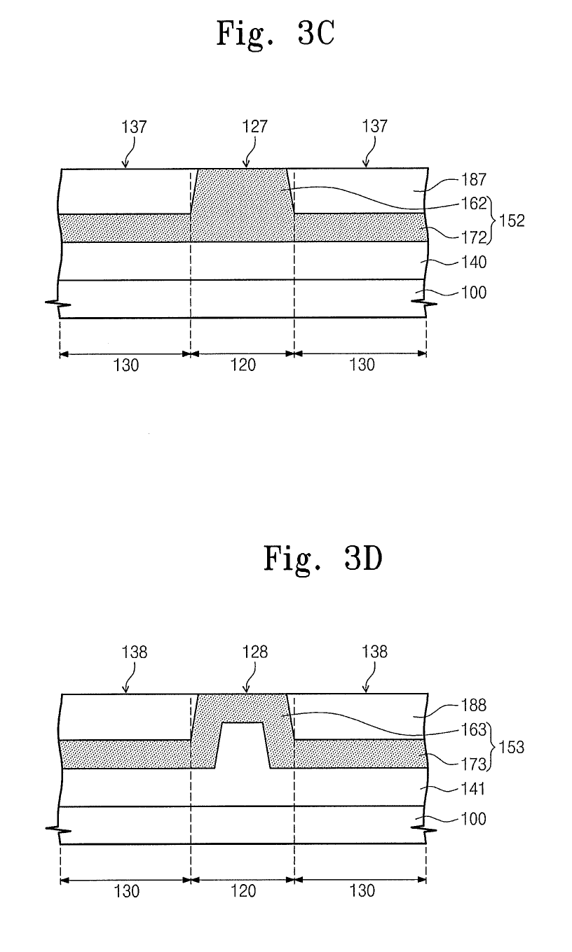

The sensing surface and non-sensing surfaces in the optical waveguide according to the first embodiment and its modifications of the present invention are disposed at respectively different levels based on the bottom surface of the lower clad. Unlike this, the sensing surface and non-sensing surfaces may be disposed at the same level based on the bottom surface of the lower clad. This will be described with reference to FIGS. 3A through 3D.

A sensing part and a passing part in the optical waveguide according to a second embodiment of the present invention are described. FIG. 3A is a sectional view taken along the line A-A′ of FIG. 1 to describe a sensing part and a passing part in the optical waveguide according to the second embodiment of the present invention.

Referring to FIG. 3A, the optical waveguide may include a core 152 on a substrate 100, and lower and upper clads 140 and 185 surrounding the core 152. The optical waveguide may include a sensing part 120 including a sensing surface 125 and passing parts 130 disposed at both sides of the sensing part 120 and including non-sensing surfaces 135.

The core 152 may include a sensing core portion 162 in the sensing part 120 and passing core portions 172 in the passing parts 130. Based on the bottom surface of the lower clad 140, the top surface of the passing core portion 172 is disposed at a first level and the central portion of the top surface of the sensing core portions 162 may be disposed at a second level higher than the first level. Based on the bottom surface of the lower clad 140, the edge of the top surface of the sensing core portions 172 may be disposed at a lower level than the second level progressively closer to the passing parts 130. Based on the bottom surface of the lower clad 140, the bottom surface of the passing core portion 172 and the bottom surface of the sensing core portion 162 may be disposed at the same level. The width of the sensing core portion 162 may be broader than that of each of the passing core portions 172 in a direction vertical to the substrate 100.

An upper clad 185 may cover the top surface of the core 152. The top surface of the upper clad 185 may be substantially flat. The thickness of the upper clad 185 covering the top surface of the sensing core portion 172 may be thinner than that of the upper clad 185 covering the top surfaces of the passing core portions 172.

The sensing surface 125 may include the top surface of the upper clad 185 covering the sensing core portion 162 and the non-sensing surfaces 135 may include the top surface of the upper clad 185 covering the passing core portions 172. Based on the bottom surface of the lower clad 140, the sensing surface 125 and the non-sensing surfaces 135 may be disposed at the same level. The distance between the sensing surface 125 and the top surface of the sensing core portion 162 may be shorter than that between the non-sensing surfaces 135 and the top surfaces of the passing core portions 172.

The sensing core portion 162 and the passing core portion 172 may include central points. For example, the distance between the central point of the sensing core portion 162 and the top surface at the second level of the sensing core portion 162 may be identical to that between the central point of the sensing core portion 162 and the bottom surface of the sensing core portion 162. The distance between the sensing surface 125 and the central point of the sensing core portion 162 may be shorter than that between the non-sensing surface 135 and the central point of the passing core portion 172.

A sensing part and a passing part in the optical waveguide according to a first modification of the second embodiment of the present invention are described. FIG. 3B is a sectional view taken along the line A-A′ of FIG. 1 to describe a sensing part and a passing part in the optical waveguide according to a first embodiment of the second embodiment of the present invention.

Referring to FIG. 3B, the optical waveguide may include a core 153 on a substrate 100, and lower and upper clads 141 and 186 surrounding the core 153. The upper clad 186 covers the top surface of the core 153 and the lower clad 141 covers the bottom surface of the core 153. The optical waveguide may include a sensing part 120 including a sensing surface 126 and passing parts 130 disposed at both sides of the sensing part 120 and including non-sensing surfaces 136.

The core 153 may include a sensing core portion 163 in the sensing part 120 and passing core portions 173 in the passing parts 130. Based on the bottom surface of the lower clad 141, the top surface of the passing core portion 173 is disposed at a first level and the central portion of the top surface of the sensing core portions 163 may be disposed at a second level higher than the first level. Based on the bottom surface of the lower clad 141, the edge of the top surface of the sensing core portions 163 may be disposed at a lower level than the second level progressively closer to the passing parts 130.

Based on the bottom surface of the lower clad 140, the bottom surface of the passing core portion 173 may be disposed at a third level and the central portion of the sensing core portion 163 may be disposed at a fourth level higher than the third level. Based on the bottom surface of the lower clad 141, the edge of the bottom surface of the sensing core portions 163 may be disposed at a level lower than the fourth level progressively closer to the passing parts 130. According to an embodiment, the width of the sensing core portion 163 may be identical to that of each of the passing core portions 172 in a direction vertical to the substrate 100.

The lower clad 141 may be disposed between the substrate 1000 and the core 153. The lower clad 141 may completely fill the space between the sensing core portion 163 and the substrate 100.

The upper clad 186 may cover the top surface of the core 153. The top surface of the upper clad 186 may be substantially flat. The thickness of the upper clad 186 covering the top surface of the sensing core portion 163 may be thinner than that of the upper clad 186 covering the top surfaces of the passing core portions 173.

The sensing surface 126 may include the top surface of the upper clad 186 covering the sensing core portion 163 and the non-sensing surfaces 136 may include the top surface of the upper clad 186 covering the passing core portions 173. Based on the bottom surface of the lower clad 141, the sensing surface 126 and the non-sensing surfaces 136 may be disposed at the same level. The distance between the sensing surface 126 and the sensing core portion 166 may be shorter than that between the non-sensing surfaces 136 and the top surfaces of the passing core portions 173.

The sensing core portion 162 and the passing core portion 172 may include central points. For example, the distance between the central point of the sensing core portion 162 and the top surface at the second level of the sensing core portion 162 may be identical to that between the central point of the sensing core portion 162 and the bottom surface at the fourth level of the sensing core portion 162. The distance between the sensing surface 126 and the central point of the sensing core portion 162 may be shorter than that between the non-sensing surface 136 and the central point of the passing core portion 172.

A sensing part and a passing part in the optical waveguide according to a second modification of the second embodiment of the present invention are described. FIG. 3C is a sectional view taken along the line A-A′ of FIG. 1 to describe a sensing part and a passing part in the optical waveguide according to a second embodiment of the second embodiment of the present invention.

Referring to FIG. 3C, the optical waveguide may include a substrate 100, a core 152, and a lower clad 140, which are described with reference to FIG. 3A. The optical waveguide may include a sensing part 120 including a sensing surface 127 and passing parts 130 disposed at both sides of the sensing part 120 and including non-sensing surfaces 137.

An upper clad 187 may be disposed on the core 152. The upper clad 187 may cover the top surface of the passing core portion 172. The upper clad 187 does not cover the central portion of the top surface of the sensing core portion 162 and covers the edge. The central portion of the top surface of the sensing core portion 162 may be exposed. The top surface of the upper clad 187 may be coplanar with that of the exposed sensing core portion 162.

The sensing surface 127 may include the top surface of the exposed sensing core portion 162. In this case, the distance between the sensing surface 127 and the top surface of the sensing core portion 162 may be 0. According to an embodiment, the sensing surface 127 may further include the top surface of the upper clad 187 covering the edge of the top surface of the sensing core portion 162. The non-sensing surface 137 may include the top surface of the upper clad 187 covering the passing core portions 172. Based on the bottom surface of the lower clad 140, the sensing surface 127 and the non-sensing surfaces 137 may be disposed at the same level. The distance between the sensing surface 127 and the top surface of the sensing core portion 162 may be shorter than that between the non-sensing surfaces 137 and the top surface of the passing core portion 172. The distance between the sensing surface 127 and the central point of the sensing core portion 162 may be shorter than that between the non-sensing surface 137 and the central point of the passing core portion 172.

A sensing part and a passing part in the optical waveguide according to a third modification of the second embodiment of the present invention are described. FIG. 3D is a sectional view taken along the line A-A′ of FIG. 1 to describe a sensing part and a passing part in the optical waveguide according to the third modification of the second embodiment of the present invention.

Referring to FIG. 3D, the optical waveguide may include the substrate 100, the core 153, and the lower clad 141, which are described with reference to FIG. 3B. The optical waveguide includes a sensing part 120 including a sensing surface 128 and passing parts 130 including non-sensing surfaces 138 and disposed at both sides of the sensing part 120.

An upper clad 188 may be disposed on the core 153. The upper clad 188 may cover the top surface of the passing core portion 173. The upper clad 188 does not cover the central portion of the top surface of the sensing core portion 163, and may cover the edge. The central portion of the top surface of the sensing core portion 163 may be exposed. The top surface of the upper clad 188 may be coplanar with that of the exposed sensing core portion 163.

The sensing surface 128 may include the top surface of the exposed sensing core portion 163. In this case, the distance between the sensing surface 128 and the top surface of the sensing core portion 163 may be 0. According to an embodiment, the sensing surface 128 may further include the top surface of the upper clad 188 covering the edge of the top surface of the sensing core portion 163. The non-sensing surface 138 may include the top surface of the upper clad 188. Based on the bottom surface of the lower clad 141, the sensing surface 128 and the non-sensing surfaces 138 may be disposed at the same level. The distance between the sensing surface 128 and the top surface of the sensing core portion 163 may be shorter than that between the non-sensing surfaces 138 and the top surface of the passing core portion 173. The distance between the sensing surface 128 and the central point of the sensing core portion 163 may be shorter than that between the non-sensing surface 138 and the central point of the passing core portion 173.

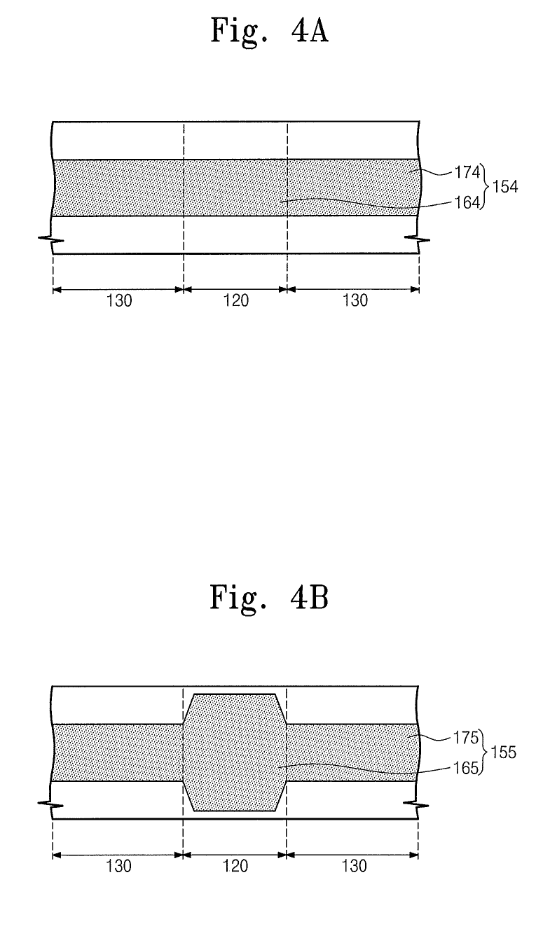

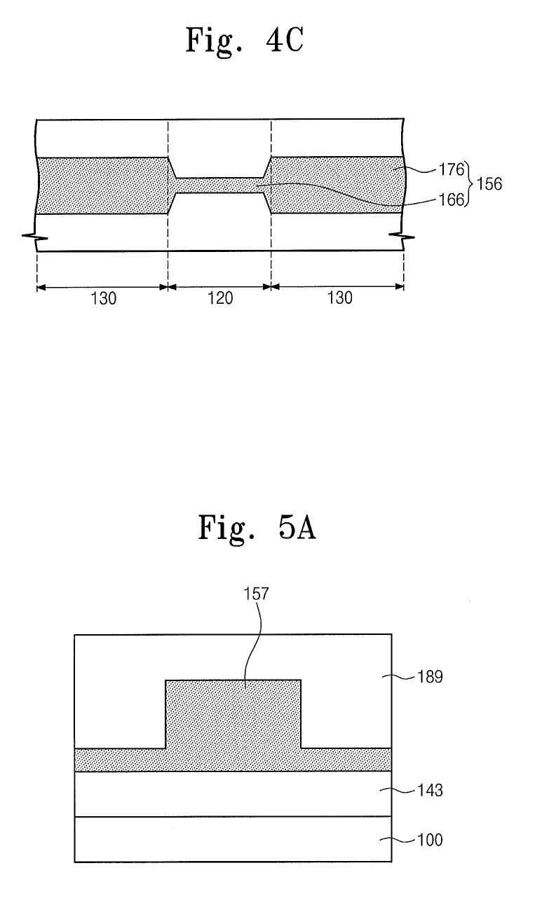

In a plane view, the width of each of the passing core portions and the width of each of the sensing core portions may be identical to or different from each other. This will be described with reference to FIGS. 4A and 4C.

A sensing part and a passing part in the optical waveguide according to a third embodiment of the present invention will be described. FIG. 4A is a plan view illustrating a sensing part and a passing part in the optical waveguide according to the third embodiment of the present invention.

Referring to FIG. 4A, the optical waveguide includes a sensing part 120 and passing parts 130 at both sides of the sensing part 120. The optical waveguide may include a core 154 where an optical signal is delivered. The core 154 may include a sensing core portion 164 in the sensing part 120 and passing core portions 174 in the passing parts 130. In a plane view, the width of the sensing core portion 164 may be identical to that of the passing core portion 174 in a direction perpendicular to the direction in which the core 154 extends.

A sensing part and a passing part in the optical waveguide according to a first modification of the third embodiment of the present invention will be described. FIG. 4B is a plan view illustrating a sensing part and a passing part in the optical waveguide according to the first modification of the third embodiment of the present invention.

Referring to FIG. 4B, the optical waveguide may include a core 155 where an optical signal is delivered. The core 155 may include a sensing core portion 165 in a sensing part 120 and passing core portions 175 in passing parts 130. In a plane view, the widths of the passing core portions 175 may be uniform in a direction perpendicular to the direction in which the core 155 extends. In a plane view, the width of the central portion of the sensing core portion 165 may be broader than that of each of the passing core portions 175 in a direction perpendicular to the direction in which the core 155 extends.

In a plane view, the width of the central portion of the sensing core portion 165 may be broader than that of the both ends of the sensing core portion 165. The width of the both ends of the sensing core portion 165 adjacent to the passing parts 130 may be narrower progressively closer to the passing parts 130.

A sensing part and a passing part in the optical waveguide according to a second modification of the third embodiment of the present invention will be described. FIG. 4C is a plan view illustrating a sensing part and a passing part in the optical waveguide according to the second modification of the third embodiment of the present invention.

Referring to FIG. 4C, the optical waveguide may include a core 156 where an optical signal is delivered. The core 156 may include a sensing core portion 166 in a sensing part 120 and passing core portions 176 in passing parts 130. In a plane view, the widths of the passing core portions 175 may be uniform in a direction perpendicular to the direction in which the core 156 extends. In a plane view, the width of the central portion of the sensing core portion 166 may be narrower than that of each of the passing core portions 176 in a direction perpendicular to the direction in which the core 156 extends.

In a plane view, the width of the central portion of the sensing core portion 166 may be narrower than that of the both ends of the sensing core portion 166. The width of the both ends of the sensing core portion 166 adjacent to the passing parts 130 may be broader progressively closer to the passing parts 130.

As described with reference to FIGS. 4A through 4C, by adjusting the width of the sensing core portion in a plane view, a change amount of an optical signal occurring when a part of a human body and/or an object contacts and/or approaches the sensing part may be adjusted.

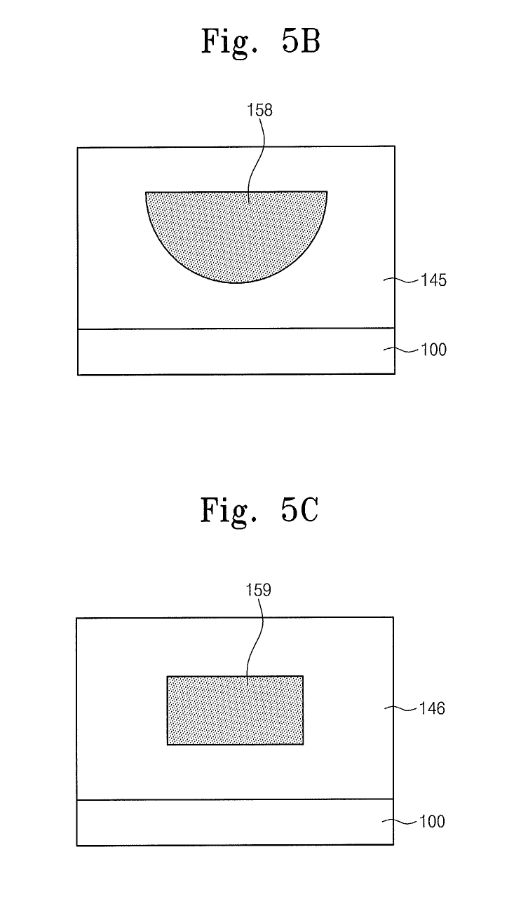

A core in an optical waveguide according to a fourth embodiment of the present invention is described. FIG. 5A is a sectional view taken along the line B-B′ of FIG. 1 to described a core in the optical waveguide according to the fourth embodiment of the present invention.

Referring to FIG. 5A, the optical waveguide may include a lower clad 143 on a substrate 100, a core 157 on a lower clad 143, and an upper clad 189 covering the core 157. The core 157 may be formed with a rip shape. For example, the core 157 may include a propagation portion and guide portions at both sides of the propagation portion. Based on the lower surface of the lower clad 143, the top surface of the propagation portion may be disposed at a higher level than the top surface of the guide portions.

A core in an optical waveguide according to a first modification of the fourth embodiment of the present invention is described. FIG. 5B is a sectional view taken along the line B-B′ of FIG. 1 to described a core in the optical waveguide according to the first modification of the fourth embodiment of the present invention.

Referring to FIG. 5B, the optical waveguide includes a core 158 on a substrate 100 and a clad 145 surrounding the core 158. The section of the core 158 may have a hemispheric shape. For example, the core 158 includes the top surface parallel to that of the substrate 100 and the bottom surface protruding toward the top surface of the substrate 100. Unlike those in the drawings, the bottom surface of the core 158 may be parallel to the top surface of the substrate 100 and the top surface of the core 158 may protrude.

A core in an optical waveguide according to a second modification of the fourth embodiment of the present invention is described. FIG. 5C is a sectional view taken along the line B-B′ of FIG. 1 to described a core in the optical waveguide according to the second modification of the fourth embodiment of the present invention.

Referring to FIG. 5C, the optical waveguide includes a core 159 on a substrate 100 and a clad 146 surrounding the core 159. The section of the core 159 may have a rectangular shape. The sides of the core 159 may be in parallel. The top surface and bottom surface of the core 159 may be parallel to the top surface of the substrate 100.

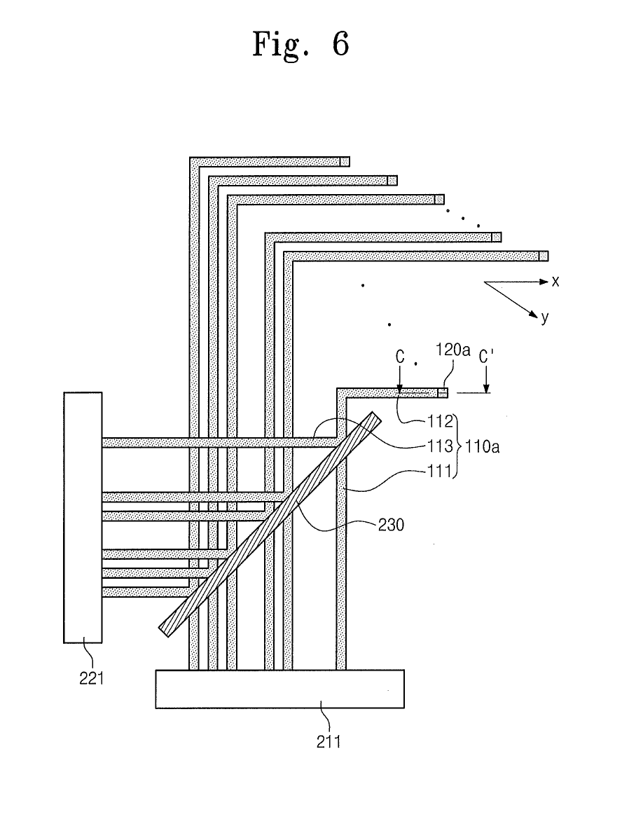

An optical touch panel including an optical waveguide according to a fifth embodiment of the present invention will be described. FIG. 6 is view illustrating an optical touch panel including the optical waveguide according to the fifth embodiment.

Referring to FIG. 6, the optical touch panel may include a plurality of optical waveguides 110a, a light generator 211 supplying an optical signal to the optical waveguides 110a, a light detector 221 receiving the optical signal through the optical waveguides 110a, and an optical filter 230.

Each of the optical waveguides 110a may include an input part 111 connected to the light generator 211, a main part 112 including a sensing part 120a, and an output part 113 outputting the optical signal. The input part 111 and the output part 113 may be connected to one end of the main part 112. The sensing part 120a may be disposed at the other end of the main part 112. The main part 112 may include a portion extending in the first direction.

The optical filter 230 may be disposed in an intersection region between the main part 112, the input part 111, and the output part 113. The optical filter 230 reflects a part of the optical signal received through the input part 111 and passes the remaining optical signal. The optical signal passing through the optical filter 211 may be delivered to the main part 112. The optical signal delivered to the main part 112 may be reflected by the sensing part 120a and then may be delivered to the optical filter 211. The optical filter transmits a part of the optical signal reflected by the sensing part 120a and reflects the remaining optical signal to the light detector 221. When a part of a human body and/or an object contacts and/or approaches the sensing parts 120a, the optical signal reflected by the sensing part 120a may be changed. Thus, the light detector 221 may detect a position of the sensing parts 120a that a part of a human body and/or an object contacts and/or approaches.

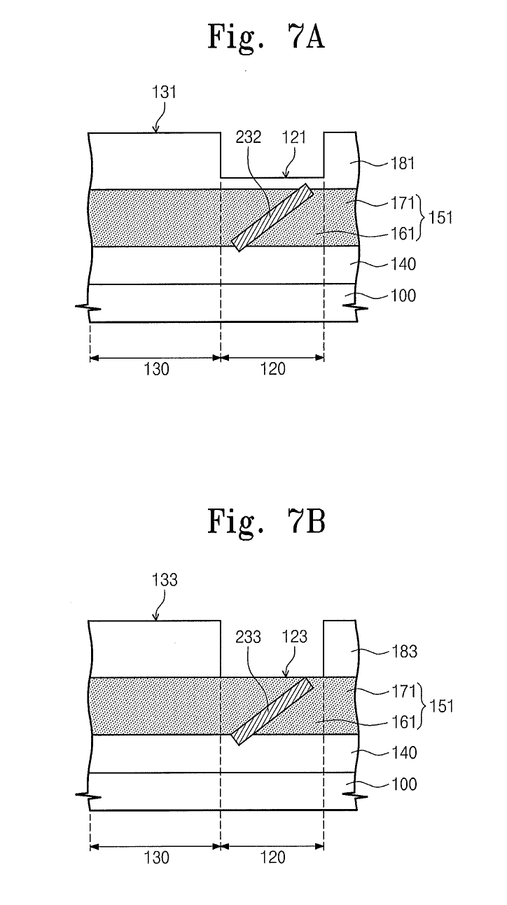

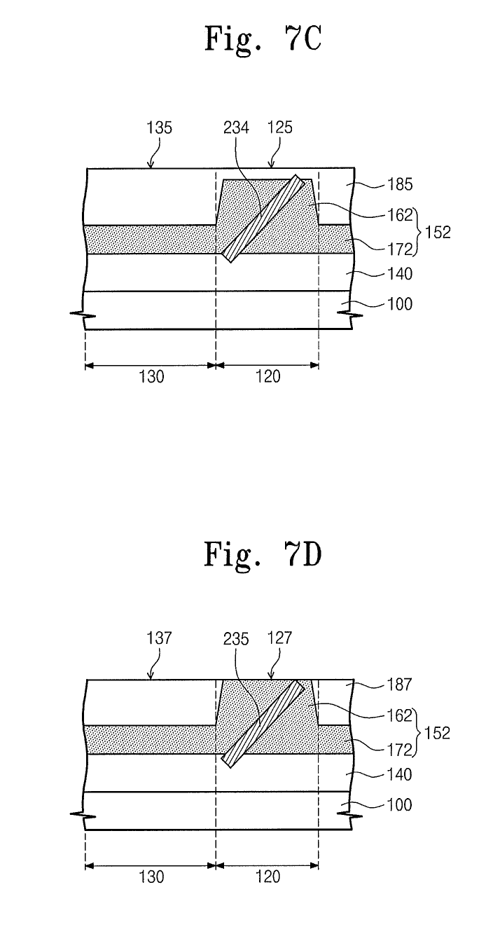

As mentioned above, the sensing part 120a may reflect the optical signal. For this, a mirror may be inserted into the core of the sensing part 120a. This will be described with reference to FIGS. 7A through 7D.

FIGS. 7A through 7D are sectional views taken along the line C-C′ of FIG. 6 to describe a sensing part in an optical waveguide according to a fifth embodiment and its modifications.

Referring to FIG. 7A, the optical waveguide according to the fifth embodiment of the present invention may include a substrate 100, a lower clad 140, a core 151, and an upper clad 181, which are described with reference to FIG. 2A. A mirror 232 may be inserted into the sensing part 120. The mirror 232 penetrates the sensing core portion 161 to be disposed in the sensing core portion 161. The mirror 232 may further penetrate the upper clad 181 covering the sensing core portion 161 and the lower clad 140 between the sensing core portion 161 and the substrate 100.

An optical signal progressing along the core 151 may be reflected by the mirror 232. When a part of a human body and/or an object contacts and/or approaches the sensing surface 121, the optical signal reflected by the mirror 232 may be changed.

Referring to FIG. 7B, the optical waveguide according to a first modification of the fifth embodiment of the present invention may include a substrate 100, a lower clad 140, a core 151, and an upper clad 183, which are described with reference to FIG. 2C. A mirror 233 may be inserted into the sensing part 120. The mirror 232 penetrates the sensing core portion 161 to be disposed in the sensing core portion 161. The mirror 233 may further penetrate the lower clad 140 between the sensing core portion 161 and the substrate 100.

Referring to FIG. 7C, the optical waveguide according to a second modification of the fifth embodiment of the present invention may include a substrate 100, a lower clad 140, a core 152, and an upper clad 185, which are described with reference to FIG. 3A. A mirror 234 may be inserted into the sensing part 120. The mirror 234 penetrates the sensing core portion 162 to be disposed in the sensing core portion 162. The mirror 234 may further penetrate the upper clad 185 covering the sensing core portion 162 and the lower clad 140 between the sensing core portion 162 and the substrate 100.

Referring to FIG. 7D, the optical waveguide according to a third modification of the fifth embodiment of the present invention may include a substrate 100, a lower clad 141, a core 153, and an upper clad 188, which are described with reference to FIG. 3C. A mirror 235 may be inserted into the sensing part 120. The mirror 235 penetrates the sensing core portion 163 to be disposed in the sensing core portion 163. The mirror 235 may further penetrate the lower clad 141 between the sensing core portion 163 and the substrate 100.

A sensing part in an optical waveguide according to another modification of the fifth embodiment of the present invention may include a mirror inserted into sensing parts in the optical waveguides described with reference to FIGS. 2B, 2D, 3B, and 3D.

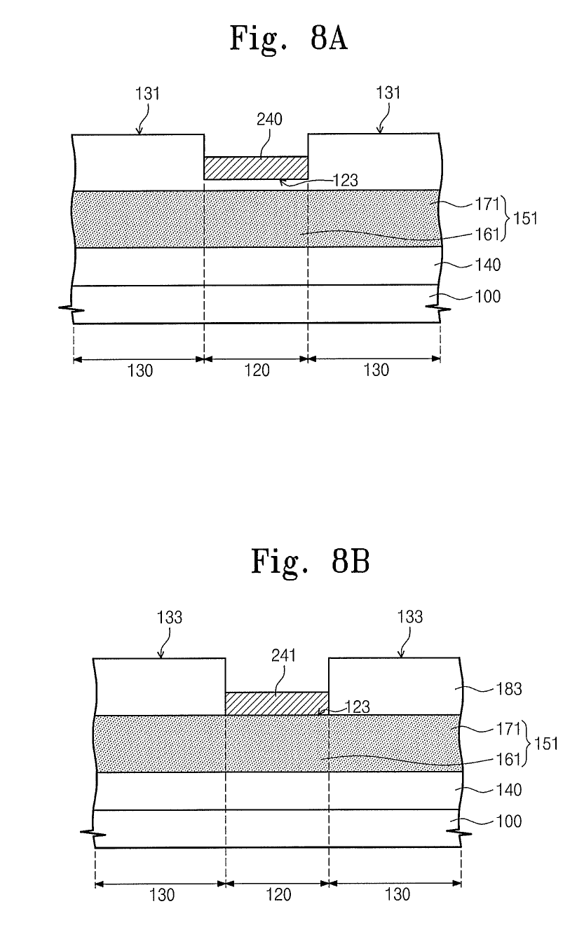

An optical touch panel including optical waveguides according to a sixth embodiment of the present invention is described. FIG. 8A is a view illustrating an optical touch panel including the optical waveguide according to the sixth embodiment of the present invention.

Referring to FIG. 8A, the optical waveguide may include a substrate 100, a lower clad 140, a core 151, and an upper clad 181, which are described with reference to FIG. 2A. A scatter pattern 240 may be disposed on the upper clad 181 covering the sensing core portion 161. The scatter pattern 240 may be disposed on a sensing surface 121. The scatter pattern 240 may contact the top surface of the upper clad 181 covering the sensing core portion 161.

The scatter pattern 240 may scatter an optical signal delivered from the core 151. For example, the optical signal scatters by the scatter pattern 240 in a direction vertical to the substrate 100 so that when a part of a human body and/or an object contacts and/or approaches the sensing part 120, an intensity of the scattered optical signal may be changed. The scatter pattern 240 may include at least one of a hologram, a diffraction grating, or a lens.

An optical touch panel including optical waveguides according to a modification of the sixth embodiment of the present invention is described. FIG. 8B is a view illustrating an optical touch panel including an optical waveguide according to the modification of the sixth embodiment of the present invention.

Referring to FIG. 8B, the optical touch panel may include a substrate 100, a lower clad 140, a core 151, and an upper clad 183, which are described with reference to FIG. 2C. A scatter pattern 240 may be disposed on a sensing surface 121. The scatter pattern 240 may contact the top surface of the sensing core portion 161.

The scatter pattern 240 described in the sixth embodiment and its modification of the present invention may be disposed on a sensing surface of a sensing part in the optical waveguide described with reference to FIGS. 2B, 2D, 3A through 3D, 4A through 4C, and 5A through 5C.

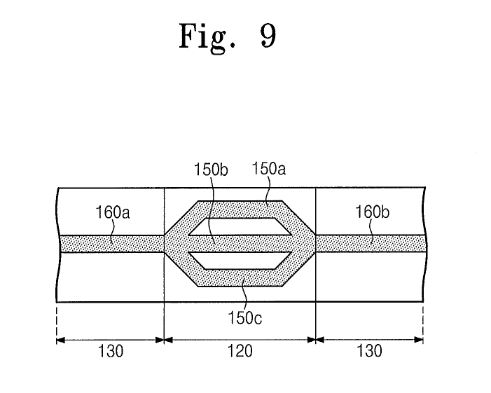

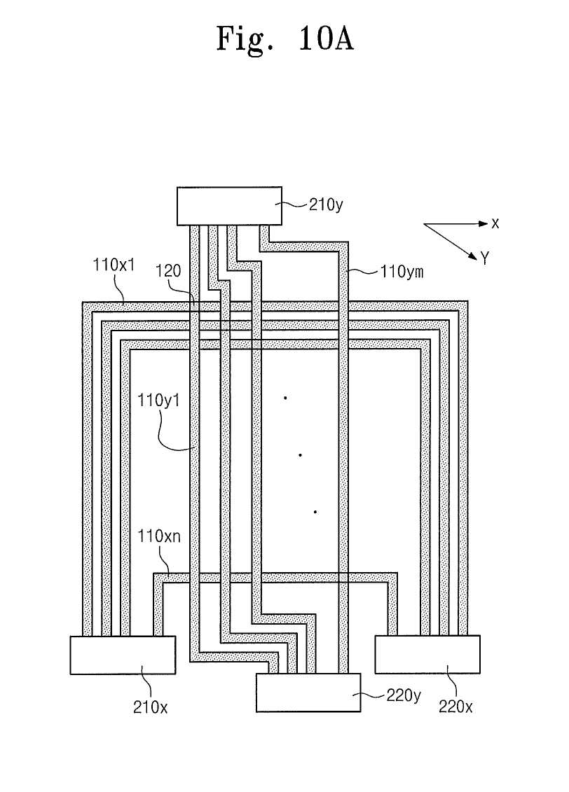

An optical touch panel including optical waveguides according to a seventh embodiment of the present invention is described. FIG. 9 is a view illustrating an optical touch panel including the optical waveguides according to the seventh embodiment of the present invention.

Referring to FIG. 9, the optical waveguide may include a plurality of sensing core portions 150a, 150b, and 150c and passing core portions 160a and 160b. The passing core portions 160a and 160b may be disposed at both sides of the sensing core portions 150a, 150b, and 150c. One ends of the sensing core portions 150a, 150b, and 150c are connected to the one end of the first passing core portion 160a, and the other ends of the sensing core portions 150a, 150b, and 150c are connected to the one end of the second passing core portion 160b. The optical signal passing through the first passing core portion 160a may be divided into the plurality of sensing core portions 150a, 150b, and 150c. The optical signal passing through the sensing core portions 150a, 150b, and 150c may be delivered to the second passing core portion 160b.

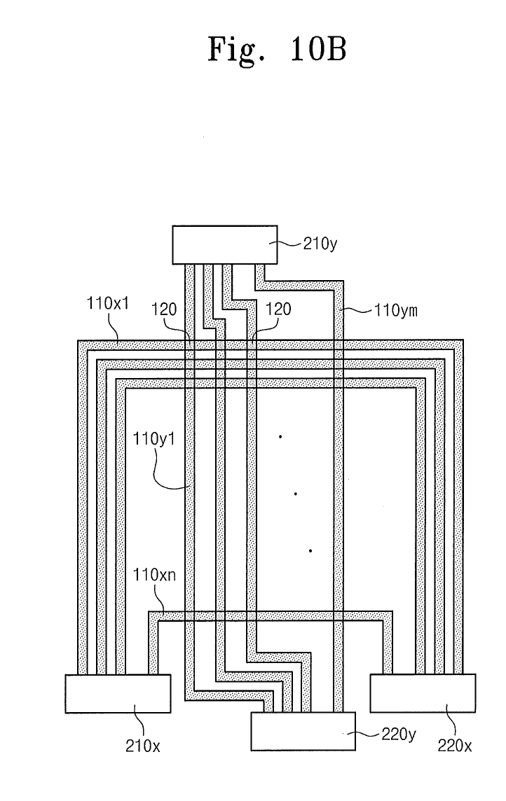

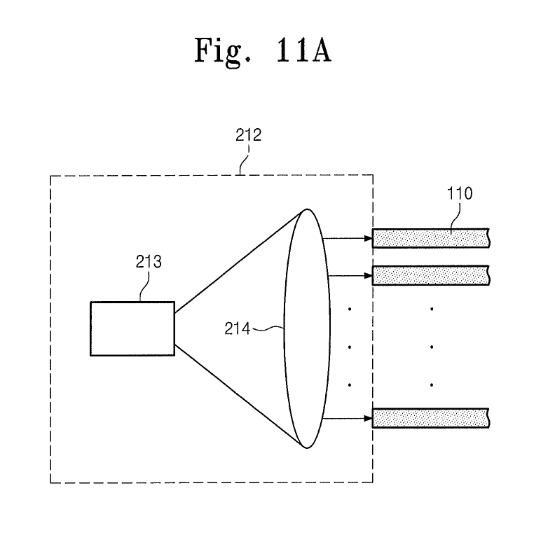

An optical touch panel including optical waveguides according to an eighth embodiment of the present invention will be described. FIG. 10A is a view illustrating an optical touch panel including the optical waveguides according to the eighth embodiment of the present invention.

Referring to FIG. 10A, the optical touch panel may include first optical waveguides 110xl to 110xn (n is an integer greater than 2), second optical waveguides 110yl to 110ym (m is an integer greater than 2), a first light generator 210x supplying first optical signals to the first optical waveguides 110xl to 110xn, a first light detector 220x measuring the first optical signals passing through the first optical waveguides 110xl to 110xn, a second light generator 210y supplying second optical signals to the second optical waveguides 110yl to 110ym, a second light detector 220y measuring the second optical signals passing through the second optical waveguides 110yl to 110ym, and sensing portions 120.

The first optical waveguides 110xl to 110xn may include portions extending parallel to a first direction. The first direction may be an x-axis direction in the drawing. The second optical waveguides 110yl to 110ym may include portions extending parallel to a direction perpendicular to the first direction.

The sensing parts 120 may be defined in an intersection region of the first and second optical waveguides 110xl to 110xn and 110yl to 110ym extending in the first direction and in a direction perpendicular to the first direction. According to an embodiment, the first optical waveguide and the second optical waveguide defining one sensing part 120 do not define another sensing part. When the first optical waveguides 110xl to 110xn are arranged in n and the second optical waveguides 110yl to 110ym are arranged in m, the sensing parts 120 may be defined by smaller one of n and m. According to an embodiment, n and m may be the same. In this case, the sensing parts 120 may be defined by n or m.

The sensing parts 120 may be arranged in a second direction non-parallel and non-vertical to the first direction. The second direction may be oblique to the first direction. The second direction may be a y-axis direction in the drawing. The sensing parts 120 may be two-dimensionally arranged along a direction vertical to the first direction and the second direction. The sensing parts 120 may be one of sensing parts described with reference to FIGS. 2A through 2D, 3A through 3D, 4A through 4C, 5A through 5C, and 8A and 8B.

An optical touch panel including optical waveguides according to a modification of the eighth embodiment of the present invention is described. FIG. 10B is a view illustrating an optical touch panel including optical waveguides according to the modification of the eighth embodiment of the present invention.

Referring to FIG. 10B, the first optical waveguides 110xl to 110xn, the second optical waveguides 110yl to 110ym, the light generators 210x and 210y, and the light detectors 220x and 220y, which are described with reference to FIG. 10A, may be provided.

The sensing parts 120 may be defined in an intersection region of the first optical waveguides 110xl to 110xn and the second light optical waveguides 110yl to 110ym extending in the first direction and a direction vertical to the first direction, respectively. According to an embodiment, the first and second optical waveguides defining the one sensing part 120 may define another sensing part 120. For example, the sensing parts 120 may be defined in all intersection regions of the first and second optical waveguides 110xl to 110xn and 110yl to 110ym.

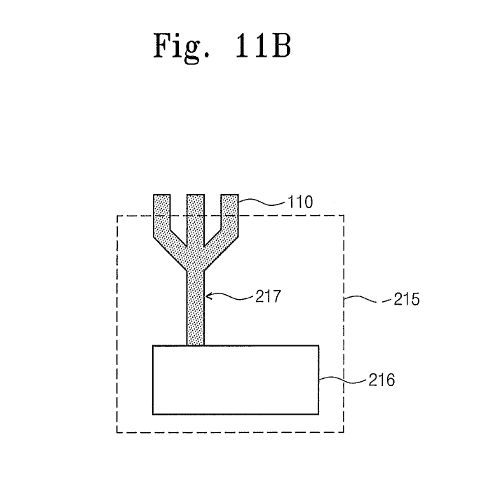

In the above-mentioned embodiments of the present invention, the light generator may include a light divider for dividing an optical signal. This will be described with reference to FIGS. 11A and 11B.

FIG. 11A is a view illustrating a light generator in an optical touch panel according to embodiments of the present invention.

Referring to FIG. 11A, the light generator 212 may include a light source 213 and a lens 214. The light source 214 may generate an optical signal. The optical signal may be delivered to the lens 214. The lens 214 may divide the optical signal into a plurality of parallel optical signals. The optical signals may be delivered to the optical waveguides 110, respectively. According to an embodiment, the light generator 212 may include one light source 213 and one lens 214. According to an embodiment, the lens 214 may include a micro-lens array. According to another embodiment, the lens 214 may be replaced with a computer generation hologram (CGH). According to another embodiment, a micro-lens array may be further disposed between the lens 214 and the optical waveguides 110, so that an intensity of the optical signal delivered to the optical waveguides may be increased.

FIG. 11B is a view illustrating a light generator in an optical touch pane according to a modification of the embodiment of the present invention.

Referring to FIG. 11B, the light generator 215 may include a light source 216 and a branch waveguide 217. The light source 216 may generate an optical signal. The branch waveguide 217 may include an input branch and a plurality of output branches connected to the input branch. One end of the input branch is connected to the light source 216 to receive the optical signal. The output branches are connected to the other end of the input branch so that the optical signal may be connected to the optical waveguides 110 through the output branches. Although three output branches are shown in the drawing, the branch waveguide 217 may include two or more than four output branches.

According to an embodiment, the light generator 215 may include a plurality of branch waveguides and the plurality of branch waveguides may supply an optical signal to the optical waveguides. According to another embodiment, the branch waveguide 217 may be replaced with a multi mode interference (MMI) or a directional coupler (DC).

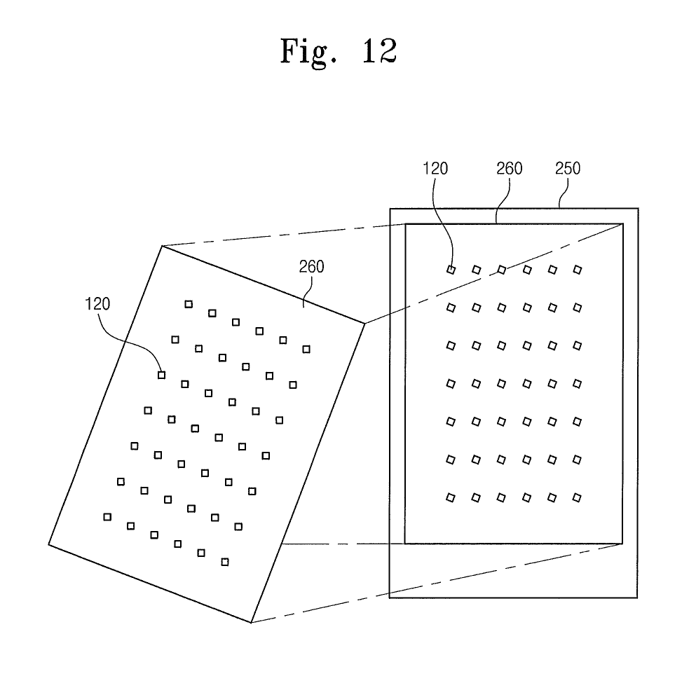

A substrate including optical waveguides with the sensing part may be disposed on a display panel. This will be described with reference to FIG. 12.

FIG. 12 is a view illustrating a touch screen panel and a display pane in an optical touch panel according to an embodiment of the present invention.

Referring to FIG. 12, the optical touch panel may include a display panel 250 and a touch screen panel 260 on the display panel 250. The display panel 250 may be a liquid crystal display panel or an organic light emitting display panel. The touch screen panel 260 may include an optical waveguide with the sensing parts 120 described in the above embodiments of the present invention.

As described with reference to FIGS. 1 and 10A, the optical waveguides extend in the first direction and the sensing parts 120 may be arranged in a direction vertical to the first direction and the second direction. The second direction may be oblique to the first direction. The touch screen panel 260 may be disposed parallel to the one side of the display panel 250 in the second direction. Thus, the sensing parts 120 may be arranged in a two-dimensional matrix on the display panel in a direction the one side of the display panel 250 extends and a direction vertical to the one side.

A layer may be interposed between the display panel 250 and the touch screen panel 260 to improve touch sensitivity. This will be described with reference to FIG. 12.

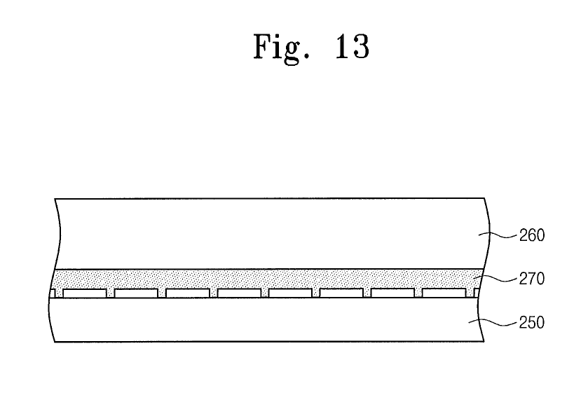

FIG. 13 is a view illustrating a touch sensitive layer in an optical touch panel according to an embodiment of the present invention.

Referring to FIG. 13, the optical touch panel may include a display panel 250, a touch screen panel 260 on the display panel 250, and a touch sensitive layer 270 between the touch screen panel 260 and the display panel 250. The touch sensitive layer 270 may include a first side contacting the touch screen panel 260 and a second side facing the first side. The second side of the touch sensitive layer 270 may include a plurality of protrusions contacting the display panel 250 and bulging surfaces spaced from the display panel 250. Between the plurality of protrusions and between the bulging surfaces and the display panel 250, empty openings may be defined. When a part of a human body and/or an object contacts and/or approaches the touch screen panel 260, the bulging surfaces and the display panel 250 contact so that touch sensitivity may be improved.

Although it is shown in FIG. 13 that the second side including the plurality of protrusions contacts the display panel 250, according to another embodiment, the second side including the plurality of protrusions may contact the touch screen panel 260.

According to an embodiment of the present invention, an optical touch panel includes an optical waveguide with a core and a clad. The optical waveguide includes a sensing part having a sensing surface and a passing part having a non-sensing surface. The core includes a sensing core portion in the sensing part and a passing core portion in the passing park. The distance between the sensing surface and the top surface of the sensing core portion may be shorter than that between the non-sensing surface and the passing core portion. Thus, an optical touch panel including a highly-reliable touch screen panel may be realized.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An optical touch panel comprising:
an optical waveguide including a core delivering an optical signal and a clad surrounding the core;
a light generator delivering the optical signal into the optical waveguide; and
a light detector measuring the optical signal passing through the optical waveguide,
wherein the optical waveguide comprises a sensing part having a sensing surface and a passing part having a non-sensing surface;
the core comprises a sensing core portion in the sensing part and a passing core portion in the passing part; and
a distance between the sensing surface and a top surface of the sensing core portion is shorter than that between the non-sensing surface and a top surface of the passing core portion.

2. The optical touch panel of claim 1, wherein a thickness of the clad covering the sensing core portion is thinner than that of the clad covering the passing core portion.

3. The optical touch panel of claim 1, wherein the sensing surface comprises the top surface of the sensing core portion.

4. The optical touch panel of claim 1, wherein the clad comprises an upper clad covering a top surface of the core and a lower clad covering a bottom surface of the core; and
the sensing surface and the non-sensing surface are disposed at the same level based on a bottom surface of the lower clad.

5. The optical touch panel of claim 4, wherein based on the bottom surface of the lower clad, the top surface of the sensing core portion is disposed at a higher level than the top surface of the passing core portion.

6. The optical touch panel of claim 5, wherein based on the bottom surface of the lower clad, a bottom surface of the sensing core portion is disposed at a higher level than a bottom surface of the passing core portion.

7. The optical touch panel of claim 5, wherein a width of the sensing core portion is broader than that of the passing core portion in a direction vertical to a direction that the optical waveguide extends.

8. The optical touch panel of claim 1, wherein the clad comprises an upper clad covering a top surface of the core and a lower clad covering a bottom surface of the core; and
based on the bottom surface of the lower clad, the non-sensing surface is disposed at a higher level than the sensing surface.

9. The optical touch panel of claim 8, wherein based on a bottom surface of the lower clad, the top surface of the sensing core portion and the top surface of the passing core portion are disposed at the same level.

10. The optical touch panel of claim 8, wherein a width of the sensing core portion is identical to that of the passing core portion in a direction vertical to a direction that the optical waveguide extends.

11. The optical touch panel of claim 1, wherein in a plane view, a width of the sensing core portion is different from that of the passing core portion in a direction perpendicular to a direction that the core extends.

12. The optical touch panel of claim 1, wherein the sensing part comprises a scatter pattern scattering the optical signal.

13. The optical touch panel of claim 1, further comprising a mirror inserted into the sensing core portion and reflecting the optical signal,
wherein the optical waveguide comprises:
a main part including the sensing part;
an input part connected to one end of the main part and receiving the optical signal; and
an output part connected to the one end of the main part and outputting the optical signal,
and further comprising an optical filter disposed on an intersection region of the main part, the input part, and the output part and delivering an optical signal reflected by the sensing part to the output part.

14. The optical touch panel of claim 1, wherein the optical waveguide is provided in plurality, further comprising an optical divider receiving the optical signal to divide the optical signal into the cores.

15. The optical touch panel of claim 1, wherein the optical waveguide is a first optical waveguide, further comprising a second optical waveguide intersecting the first optical waveguide, wherein the sensing part is disposed in an intersection region of the first and second optical waveguides.

16. The optical touch panel of claim 15, wherein the second optical waveguide is provided in plurality;
the plurality of second optical waveguides intersect the first optical waveguide; and
the sensing part is provided in plurality in an intersection region of the first optical waveguide and the second optical waveguide.

17. The optical touch panel of claim 1, wherein the optical waveguide is provided in plurality and the optical waveguides extend in parallel in a first direction;
the sensing parts form rows and columns, respectively, along a direction vertical to the first direction and a second direction;
the second direction is non-vertical and non-parallel to the first direction; and
the second direction is parallel to one side of a display panel.

18. The optical touch panel of claim 1, further comprising a touch sensitive layer including a plurality of protrusions.

19. The optical touch panel of claim 1, wherein the light generator comprises:
a light source generating the optical signal; and
at least one lends converting the optical signal into a direction parallel to an extension direction of the optical waveguide and delivering the converted optical signal into the optical waveguide.

20. The optical touch panel of claim 1, wherein the passing core portion comprises first and second passing core portions at both sides of the sensing core portion;
the sensing core portion provided in plurality;
one ends of the plurality of sensing core portions are connected to one end of the first passing core portion; and
the other ends of the plurality of sensing core portions are connected to one end of the second passing core portion.
